(19) United States
(12) Patent Application Publication
(10) Pub. No.: US 2019/0005758 A1
(43) Pub. Date: Jan. 3, 2019

(54) OBJECT AND SYSTEM FOR DUPLICATION PREVENTION USING RANDOM MEDIA, AND DUPLICATION PREVENTION METHOD USING SAME

(71) Applicant: DAEGU GYEONGBUK INSTITUTE OF SCIENCE AND TECHNOLOGY, Dalseong-gun, Daegu (KR)

(72) Inventor: Chil Min Kim, Seoul (KR)

(21) Appl. No.: 15/753,669

(22) PCT Filed: Aug. 19, 2016
(86) PCT No.: PCT/KR2016/009142

§ 371 Date: Feb. 20, 2018

(30) Foreign Application Priority Data
Aug. 19, 2015 (KR) 10-2015-0116934

(51) Int. Cl. G07D 7/202; B42D 25/328; B42D 25/36; G07D 7/00; G07D 7/2033

(52) U.S. Cl. CPC G07D 7/205; B42D 25/328; B42D 25/23; G07D 7/0032; G07D 7/2033; B42D 25/36

(57) ABSTRACT

The present invention relates to a system and method for preventing duplication by determining, using random media, whether an object (money, an identification card, a credit card, or the like) is counterfeited or duplicated. An object for preventing duplication by using random media, according to the present invention, includes a random medium in which a plurality of particles having irregular sizes and shapes are mixed, wherein the particles are obtained by pulverization or nano-processing of different media or the same media.

### TECHNICAL FIELD

The present invention relates to a system and method for preventing duplication by determining whether an object (money, an identification card, a credit card, or the like) is counterfeited or duplicated by using random media.

### BACKGROUND ART

Counterfeit money refers to fake currency produced by a person who is not a currency issuer, which causes the general public to think that the fake currency is genuine.

In addition, there are an increasing number of cases of violations of the Specialized Credit Financial Business Act, in which cards received for payment or cards inserted into ATMs are illegally duplicated.

According to the prior art, encryption chips are used to prevent duplication of credit cards, and in the case of money, to prevent the money from being counterfeited or duplicated, printing methods, ink, and paper have been developed, and holograms, micro-perforation, steganography, which is a digital watermarking method, and the like have been proposed.

Despite the development of these methods, there is an extremely difficult problem in that, when a large group attempts to duplicate money, such as US super notes (super precise counterfeit dollars), the public cannot accurately detect the duplication of the counterfeit money.

### DETAILED DESCRIPTION OF THE INVENTION

### Technical Problem

The present invention has been proposed to address the above-described problems, and it is an object of the present invention to provide a system and method capable of preventing counterfeiting or duplication by forming a random medium, including the random medium in an object (money, a credit card, a debit card, an identification card, or the like), and determining whether the object is counterfeited or duplicated by using, as a fingerprint, a unique pattern of light formed when the object is irradiated with light.

### Technical Solution

According to the present invention, an object for preventing duplication by using a random medium includes a random medium in which a plurality of particles having irregular sizes and shapes are mixed, wherein the particles are obtained by pulverization or nano-processing of media having different refractive indices or the same media.

According to the present invention, a system for preventing duplication by using a random medium includes an object including a random medium, and a reader configured to irradiate the object with light and read whether the object is duplicated by using a pattern formed by the random medium.

According to the present invention, a method of preventing duplication by using a random medium includes: forming a random medium having a plurality of particles mixed randomly, wherein the random medium includes luminescent particles that emit light in response to incident light; including the random medium including the luminescent particles in the object; and irradiating the random medium arranged in the object with a plurality of light beams having different wavelengths and reading whether the object is counterfeited by using a pattern formed according to each of the light beams.

### Advantageous Effects of the Invention

According to the present invention, a random medium, in which particles having different shapes and refractive indices are randomly arranged, is formed, and by using, as a fingerprint, a unique pattern of light formed by irradiating the random medium with light, forgery or duplication of an object (money, a credit card, a debit card, an identification card, or the like) can be read and prevented.

When particles having different sizes and shapes are agglomerated with one another, the particles are naturally arranged randomly, and thus it is impossible to duplicate a random medium including these particles having various refractive indices mixed therein, and, accordingly, a duplication prevention effect of higher reliability than other duplication prevention techniques is obtained.

In addition, according to the present invention, a final random medium is formed such that luminescent materials are irregularly mixed in a random medium, and irradiating the final random medium with a plurality of light beams having different wavelengths, thereby being capable of fundamentally preventing holographic duplication.

Whether an object is counterfeited or duplicated may be accurately determined by storing a serial number (e.g., a card serial number and a money serial number) and a unique pattern of an object, emitting light to an object (money, a credit card, a debit card, an identification card, or the like) when in use to acquire a pattern, and comparing the acquired pattern with the stored unique pattern.

Effects of the present invention are not limited to the aforementioned effects, and other unmentioned effects will become apparent from the following description to those of ordinary skill in the art.

### DESCRIPTION OF THE DRAWINGS

FIG. 1 is a view of a random medium according to an embodiment of the present invention.

FIG. 2 is a conceptual view illustrating a system for preventing duplication by using a random medium, according to an embodiment of the present invention.

FIG. 3 is an example view illustrating patterns formed when light passes through a random medium, according to an embodiment of the present invention.

FIG. 4 is a flowchart illustrating a method of preventing duplication by using a random medium, according to an embodiment of the present invention.

### BEST MODE

The above-described objects, other objects, advantages, and characteristics of the present invention, and methods performed to achieve the same will become apparent from the accompanying drawings and embodiments described below in detail.

However, the present invention is not limited to the embodiments set forth herein and may be embodied in many different forms. Rather, the following embodiments are merely provided so that the objects, configurations, and effects of the present invention are easily understood by those of ordinary skill in the art to which the present invention pertains, and the scope of the present invention is defined by the description of claims.

Meanwhile, the terms used in the present specification are provided only for illustrative purposes and are not intended to limit the present invention. As used herein, the singular forms include the plural forms as well unless otherwise specifically mentioned in the context. The terms “comprises” and/or “comprising,” as used herein, specify the presence of stated elements, steps, operations, and/or components, but do not preclude the presence or addition of one or more other elements, steps, operations, and/or components.

Prior to the description of example embodiments of the present invention, hereinafter, the background of the present invention will be described to facilitate the understanding of those skilled in the art.

Research on various properties of random media has been conducted, and these various studies have been conducted not only on the transmission and scattering of light in random media, but also on Anderson localization where light is confined inside random media (which predicts that electrons may become immobile when placed in disordered lattices).

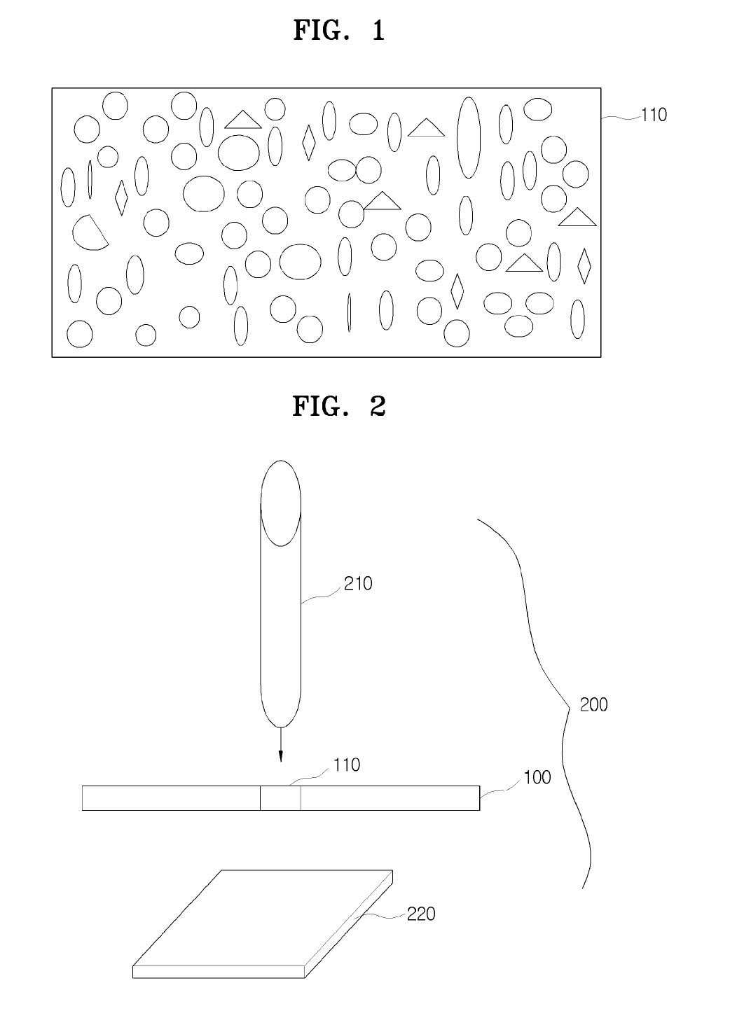

The present invention relates to a technique for determining whether an object (a credit card with goods-value, a debit card, money, an identification card commonly used for identification, or the like) is counterfeited or duplicated, using characteristics of a random medium through which light passes or by which light is reflected. Hereinafter, example embodiments of the present invention will be described in detail with reference to FIGS. 1 to 4.

FIG. 1 is a view of a random medium 110 according to an embodiment of the present invention.

The random medium 110 is generally defined as an agglomerate of small media, and, when micrometer-sized silicas are agglomerated with one another, these silicas are naturally randomly arranged, and thus it is impossible to produce the same random medium 110 as the produced random medium 110.

The random medium 110 may consist of media having different refractive indices as described below, but may also be formed using a single medium.

An object for preventing duplication by using a random medium (as described above, including a credit card with goods-value, a debit card, money, an identification card commonly used for identification, or the like), according to an embodiment of the present invention, includes the random medium 110 in which a plurality of particles having irregular sizes and shapes are mixed, wherein the particles are acquired by grinding process or nano-processing of media having different refractive indices.

When a hologram is obtained by Fourier transforming a pattern of light passing through a random medium, it is possible to restore the pattern to some extent when light having the same wavelength is incident on the hologram.

Thus, according to an embodiment of the present invention, to prevent such duplication, luminescent particles are irregularly mixed in the random medium 110.

In this case, luminescent particles are nano- or micro-particles, and light emitted from a luminescent object undergoes Anderson localization due to a random medium formed by different particles, and thus a more complex pattern is formed than in the case of a random medium excluding luminescent particles, and, accordingly, a pattern different from a pattern formed by externally incident light in the absence of a luminescent material is formed.

Even in a case in which an unauthorized third party attempts duplication by forming a hologram through Fourier transformation using the formed pattern, when the hologram is irradiated with light having the same wavelength, the formed pattern differs (i.e., duplication is impossible) from a pattern formed by a random medium including luminescent particles, and thus, according to embodiments of the present invention, the present invention is effective in fundamentally preventing holographic duplication.

In addition, when the random medium 110 is irradiated with a plurality of light beams having different wavelengths, patterns produced by the respective light beams are different from each other.

According to Fourier optics, when a random medium is replaced with a hologram, a pattern similar to the random medium may be obtained only by the same wavelength, and, when light beams having different wavelengths are used, patterns produced by the respective light to beams passing through the random medium 100 are different from each other.

That is, when an unauthorized third party attempts duplication, only a single hologram has to be used, and, although a hologram is formed by Fourier transforming patterns formed by irradiating the random medium 110 with a plurality of light beams having different wavelengths, patterns produced by the respective light beams passing through the random medium 110 differ from patterns formed by irradiating the hologram with the respective light beams.

Thus, according to an embodiment of the present invention, when the type of light with which the random medium 110 is irradiated is determined as a plurality of light beams having different wavelengths, patterns produced by the respective light beams are stored, and then the patterns according to the respective wavelengths are compared with each other, and a pattern different from a hologram formed by Fourier transformation is formed, and, accordingly, it is possible to determine whether an object is duplicated.

As described above, according to an embodiment of the present invention, a random medium including luminescent particles is formed, and a plurality of light beams having different wavelengths are used in determining authenticity, and thus, even when a third party uses a hologram formed by Fourier transformation, it is impossible to duplicate the object, and, accordingly, reliability thereof may be secured.

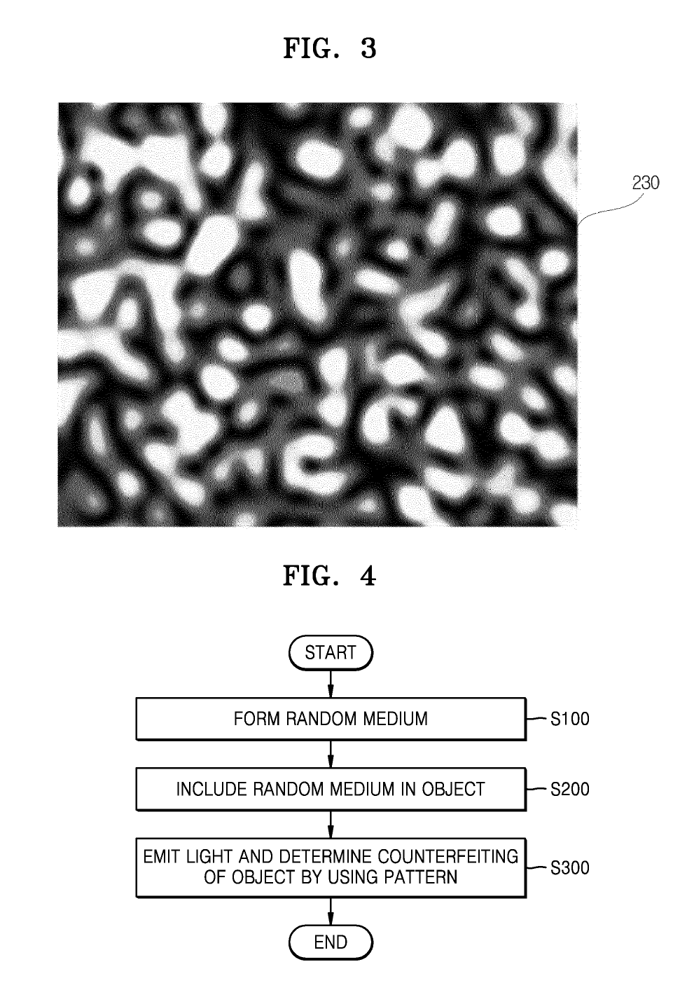

When light having the same wavelength is incident on a randomly arranged agglomerate (random medium 110) in the same direction, the same pattern, e.g., a pattern 230 as illustrated in FIG. 3, is formed all the time.

That is, in a case in which the optical phenomenon is used, scattering occurs when light passes through the random medium 110, and when transmitting light or reflected light is shone on a screen (a CCD array 220 according to the following embodiment of the present invention) through the collection of scattered light beams, the pattern 230, which is complicated due to light interference, is produced. The pattern 230 varies according to the position, size, shape, refractive index of the random medium 110.

According to an embodiment of the present invention, the random medium 110 acquired using the above-described method is included in the object 100 to determine whether the object 100 is counterfeited or duplicated, and thus it is possible to determine whether the object 100 is counterfeited or duplicated, by using a principle that a pattern showing a significant difference in spite of an insignificant difference in particles is formed.

That is, an agglomerate of randomly arranged small media, i.e., the random medium 110, is formed to have a certain size, luminescent particles are included therein, and then the random medium 110 is included in the object 110, and whether the object 110 is counterfeited or duplicated is determined using the pattern 230 formed by irradiating the object 110 with light.

The random medium 110 has to be formed so as to prevent duplication, and thus is formed such that various types of media having different refractive indices are prepared, the media is subjected to pulverization or nano-processing to obtain particles having a size of several nanometers to 1 millimeter, and luminescent particles are included therein.

At this time, particles may also be obtained using a single medium.

Since various particles having irregular shapes and sizes are prepared and the used media have different refractive indices, when these are mixed, the random medium 110 in which particles having different sizes, shapes, and refractive indices are mixed may be obtained.

The random medium 110 may be included in a film, and may also be formed by randomly mixing and arranging particles inside a glass material.

The thickness of a film is determined in consideration of the thickness of an object (money, a credit card, or the like), and the size thereof is determined in consideration of the size of a light source and the size and resolution of a CCD array. In an example embodiment, the film may have a square shape with a size of 1 cm² or less, most preferably, no more than 1 mm².

FIG. 2 is a conceptual view illustrating a system for preventing duplication by using the random medium 110, according to an embodiment of the present invention.

The system for preventing duplication by using the random medium 110, according to an embodiment of the present invention, includes the object 100 including the random medium 110, and a reader 200 configured to read whether the object 100 is duplicated, using a pattern formed by the random medium 110.

The pattern formed by the random medium 110 according to the above-described method may vary according to a direction in which light is incident, and this is due to the interference phenomenon caused by complex paths of an optical path through which light passes and a path of light scattered from the random medium 110.

Thus, according to an embodiment of the present invention, the reader 200 includes a light source unit 210 configured to emit light to a position in which the random medium 110 is located, and the CCD array 220 on which an interference pattern is formed by light having passed through the random medium 110. A light source of the light source unit 210 may be a diode laser, an LED, an OLED, or the like that has good characteristics of monochromatic light and several wavelengths, and more precise identification is possible using a pattern produced according to the color of light.

In the reader 200 according to an embodiment of the present invention, whether an object is duplicated is determined using patterns produced by respectively emitting a plurality of light beams having different wavelengths using the light source unit 210.

However, embodiments of the present invention are not limited to the above embodiments, and identification using a low-resolution CCD camera is also possible.

A pattern produced by light that has passed through or been reflected by the random medium 110 is used as a fingerprint of the object 100 and may be simply measured using the CCD array 220, and since a laser uses monochromatic light, data for the pattern may be sufficiently acquired only using a monochrome CCD array.

As illustrated in FIG. 2, the random medium 110 is included in a predetermined portion of the object 100, which is money or a genuine card, and, as described above, the random medium 110 is formed in a film having a predetermined size according to the size and resolution of the CCD array 220, followed by printing on the object 100, or is formed such that particles are randomly arranged and inserted in a housing made of a glass material.

In an embodiment of the present invention, the housing is surface-coated with a material of high hardness (e.g., sapphire) to prevent scratch formation.

Since the housing is coated with a material of high hardness, the formation of scratch on the housing due to external environmental factors according to the use of an object is prevented, and thus when light is emitted, pattern distortion may be prevented.

The light source unit 210 accurately targets the random medium 110 and emits light according to a predetermined irradiation angle, and a pattern is obtained using a mark that indicates a position of the random medium 110 (an identification tag internally or externally inserted into a random medium).

The reader 200 according to an embodiment of the present invention transmits patterns formed on the CCD array 220 to a data center, and the data center receives results of determination of counterfeiting or forgery, which are results of comparison between pre-stored patterns and the transmitted patterns.

As a result of determination, if there is no abnormality, the reader 200 approves payment or identification, whereas if there is an abnormality, the reader 200 displays a separate alarm message or informs a user' smart terminal of the fact of illegal use or the like, thereby preventing an object from being counterfeited or duplicated.

When the reader 200 transmits a pattern formed according to irradiation of light to a data center, the reader 200 transmits the pattern together with a serial number included in an object.

The data center receives, from the reader 200, a serial number of the object 100 required to be currently used and a pattern acquired in the CCD array 220, and determines whether the to object 100 is normally used, by comparing the serial number and the pattern with a pre-stored object serial number and a unique pattern matched therewith.

At this time, a small error may occur between the unique pattern and the acquired pattern, and the data center includes an algorithm for obtaining a spatial correlation therebetween to offset this error and determining the object 100 as an authentic object when the spatial correlation is equal to or greater than a certain probability.

That is, in obtaining the spatial correlation, when the random media 110 are different from each other, it is obtained that there is theoretically no correlation.

In addition, when it is determined that the spatial correlation is equal to or greater than a certain probability, a slight error may occur in data due to scratch or the like on a surface of the random media 110, but this case is actually read as the same random media.

The data center obtains a spatial correlation and informs the reader 200 of an object being authentic if the spatial correlation is equal to or greater than a predetermined probability, and informs the reader 200 of an object being counterfeited or duplicated if a probability according to the correlation is less than the predetermined probability.

FIG. 4 is a flowchart illustrating a method of preventing duplication by using a random medium, according to an embodiment of the present invention.

The method of preventing duplication by using a random medium, according to an embodiment of the present invention, includes: forming a random medium including a plurality of particles mixed in a random arrangement (operation S100); including the random medium in an object (operation S200); and emitting light to the random medium arranged in the object and reading whether the object is counterfeited, using the formed pattern (operation S300).

As described above, operation S100 is a process of forming a random medium that is not duplicable, by agglomerating particles having different sizes, shapes, and refractive indices with one another.

That is, in operation S100, particles are acquired by pulverization or nano-processing of media having different refractive indices, and a random medium is formed using particles having irregular sizes and shapes, wherein the random medium includes luminescent particles.

In operation S200, the random medium formed in operation S100 is included in a predetermined portion of an object (money or a genuine card) by using a mark (an identification tag internally or externally added to the random medium) that indicates the position of the arranged random medium.

In operation S300, which will be described below, the mark is used to identify a pattern and to determine the position of the pattern when determining whether an object is counterfeited to by comparing the identified pattern with the pre-stored unique pattern.

Operation S300 is a process of transmitting, to a data center, a pattern formed by irradiating the random media with light by using a laser or a light-emitting diode (LED), and determining whether an object is counterfeited by receiving, from the data center, results of comparison between a pattern matched with a pre-stored serial number of the object and the transmitted pattern.

At this time, in operation S300, whether an object is counterfeited is determined using patterns respectively formed by a plurality of light beams having different wavelengths and respectively emitted.

In operation S300, the use of a copy hologram generated by Fourier transformation for the use of an object is read by measuring a reflection pattern formed by the random medium including a luminescent material, thereby determining whether the object is counterfeited.

At this time, the pre-stored unique pattern is compared with the transmitted pattern by using the spatial correlation, and in a case in which the spatial correlation is equal to or greater than the predetermined probability, it is determined that the object is genuine.

That is, the formed pattern and a serial number of an object needed to be used are identified and transmitted to the data center, and the data center determines whether the object needed to be used is authentic, or counterfeited or duplicated by comparing the pre-stored pattern and the serial number of an object with the transmitted pattern and serial number.

According to an embodiment of the present invention, in a subsequent process of operation S300, the use of an object (payment or identification) is approved when the object is genuine, the use of an object is disapproved according to use stop request when it is determined that the object is counterfeited or duplicated, and this is informed to a user's terminal of the object, or records of illegal use requests are stored and managed in a separate database.

Embodiments of the present invention have been described. It will be understood by those of ordinary skill in the art that various changes in form and details may be made herein without departing from the essential characteristics of the present invention. Thus, it should be understood that the embodiments described herein should be considered in a descriptive sense only and not for purposes of limitation. The scope of the present invention is shown not in the above description but in the claims, and all differences within the range equivalent thereto will be interpreted as being incorporated in the present invention.

1. An object for preventing duplication by using a random medium, the object comprising:
a random medium including a plurality of particles mixed therein, the particles having irregular sizes and shapes,
wherein the particles are obtained by pulverization or nano-processing of media having different refractive indices.

2. The object of claim 1, wherein the random medium forms a unique pattern corresponding to a speckle formed as emitted light passes through the random medium.

3. The object of claim 1, wherein the random medium is formed using particles obtained by pulverization or nano-processing of media having different refractive indices or the same media, wherein the particles are randomly mixed and arranged in a polymer film or a glass material.

4. The object of claim 1, wherein the random medium further comprises luminescent particles that emit light in response to incident light.

5. A system for preventing duplication by using a random medium, the system comprising:
an object including a random medium; and
a reader configured to irradiate the object with light and read whether the object is duplicated, by using a pattern, the pattern being a unique interference form of the random medium resulting from transmission of light through the random medium.

6. The system of claim 5, wherein the random medium has a configuration selected from the group consisting of:
the random medium is formed using particles obtained by pulverization or nano-processing of media having different refractive indices, and is formed by mixing particles with each other, the particles having irregular sizes and shapes and different refractive indices;
the random medium is included in a predetermined portion of the object, the object being money or a genuine card;
the random medium is included in a predetermined portion of the object, the object being money or a genuine card, and the genuine card is an identification card or a financial card;
the random medium is formed in a film having a predetermined size according to a size and a resolution of a CCD array, printed on the object, and coated with a material of high hardness; and
the random medium is formed using particles that are inserted, in a random arrangement, into a glass material or a polymer housing.

7. The system of claim 5, wherein the random medium further comprises luminescent particles.

8.-11. (canceled)

12. The system of claim 5, wherein the random medium is formed using particles that are inserted, in a random arrangement, into a housing, and the housing is coated with a material of high hardness to prevent scratch formation.

13. The system of claim 5, wherein the reader comprises a light source unit configured to emit light to a position of the random medium, and a CCD array on which an interference pattern is formed by light having passed through the random medium.

14. The system of claim 13, wherein the reader emits each of a plurality of light beams having different wavelengths by using the light source unit and reads whether the object is duplicated, by using a pattern produced by each of the light beams.

15. The system of claim 13, wherein the light source unit emits light using a laser or a light-emitting diode (LED).

16. The system of claim 13, wherein the light source unit accurately targets a position of the random medium and emits light to the random medium according to a predetermined irradiation angle, and a pattern formed by light having passed through the random medium is acquired and analyzed using a mark that indicates the position.

17. The system of claim 13, wherein the reader transmits the pattern formed on the CCD array to a data center, and the data center receives determination results of counterfeiting, the determination results being results of comparison between a pre-stored pattern and the transmitted pattern.

18. The system of claim 17, wherein, when the reader transmits the pattern formed according to irradiation of light to the data center, the readers transmits, together with the pattern, an object serial number included in the object.

19. The system of claim 13, wherein the data center determines counterfeiting by comparing the pre-stored pattern and the transmitted pattern by using a spatial correlation. The system of claim 13, wherein the data center determines counterfeiting by comparing the pre-stored pattern and the transmitted pattern by using a spatial correlation.

20. A method of preventing duplication by using a random medium, the method comprising:
(a) forming a random medium comprising a plurality of particles mixed in a random arrangement, the particles having irregular sizes and shapes;
(b) including the random medium in an object; and
(c) irradiating the random medium included in the object with light and reading whether the object is counterfeited, by using a pattern formed by light having passed through the random medium, the pattern being an interference form.

21. The method of claim 20, wherein, in process (a), the random medium is formed by obtaining particles by pulverization or nano-processing of media having different refractive indices or the same media, wherein luminescent particles are included in the random medium.

22. The method of claim 21, wherein, in process (c), whether a copy hologram generated by Fourier transformation is used is determined using a pattern formed by the random medium including the luminescent particles.

23. The method of claim 20, wherein, in process (b), the formed random medium is included in a predetermined portion of money or a genuine card by using a mark that indicates a position of the random medium.

24. The method of claim 20, wherein process (c) is performed by transmitting a pattern formed by irradiating the random medium with light from a laser or a light-emitting diode (LED), receiving results of comparison between a pattern matched with a pre-stored object serial number and the transmitted pattern, and reading whether the object is counterfeited, according to the comparison results, wherein the light is each of a plurality of emitted light beams having different wavelengths, and whether the object is counterfeited is read using a pattern formed by each of the light beams.
